(19) United States
(12) Patent Application Publication
(10) Pub. No.: US 2011/0293134 A1
(43) Pub. Date: Dec. 1, 2011

(54) SPEAKER

(76) Inventor: Jin-Quan HUANG, Shenzhen (CN)

(21) Appl. No.: 12/978,589

(22) Filed: Dec. 26, 2010

(30) Foreign Application Priority Data
May 25, 2010 (CN) 201010182964.4

(51) Int. Cl. H04R 1/00

(52) U.S. Cl. 381/412; 381/150

(57) ABSTRACT

A speaker having a voice coil is disclosed. The voice coil includes two parallel main members and two linking members connecting the two main members for forming a closed loop, one of the linking member having at least a first part from a first circle having a first diameter, and at least a second part from a second circle having a second diameter greater than the first diameter.

### BACKGROUND OF THE INVENTION

1. Field of the Invention

The present invention generally relates to electro-magnetic transducers, and more particularly to a speaker having a voice coil.

2. Description of Related Art

In recent years, with the proliferation of slim-type electronic devices such as liquid crystal display devices, mobile telephones, there is a demand for thin-type and slim-type speakers with high performance. Generally, a speaker includes a magnetic circuit system for generating electro-magnetic force to drive a coil thereof to vibrate. Typically, the magnetic circuit system includes a yoke, a magnet positioned on the yoke, and a top plate attached to the magnet. A magnetic gap is formed between the yoke and the magnet. If a coil is suspended in the magnetic gap, when electrified, the coil will be given a magnetizing force, and the force is determined by the product of magnetic flux B, displacement of the coil L, and current applied on the coil. Production of B and L is called magnetizing force factor.

A voice coil used in a related speaker comprises two parallel linear members, and two arc members connecting two ends of the linear members respectively. The linear members and the arc members define a closed loop, like a standard run track. The arc member is generally a half circle. A speaker with such a coil has low sensitivity because it increases the length of the voice coil but contributes little for sensitivity.

So, it is necessary to provide an improved voice coil and a speaker using the voice coil for solving the problems mentioned above.

### BRIEF DESCRIPTION OF THE DRAWINGS

FIG. 1 is an exploded view of a speaker in accordance with one embodiment of the present invention;

FIG. 2 is a cross-sectional view of the speaker in FIG. 1;

FIG. 3 is a top view of a voice coil used in the speaker of the present disclosure;

Many aspects of the embodiments can be better understood with reference to the drawings mentioned above. The components in the drawings are not necessarily drawn to scale, the emphasis instead being placed upon clearly illustrating the principles of the present disclosure. Moreover, in the drawings, like reference numerals designate corresponding parts throughout the several views.

### DETAILED DESCRIPTION OF THE EXEMPLARY EMBODIMENT

Reference will now be made to describe the exemplary embodiment of the present invention in detail.

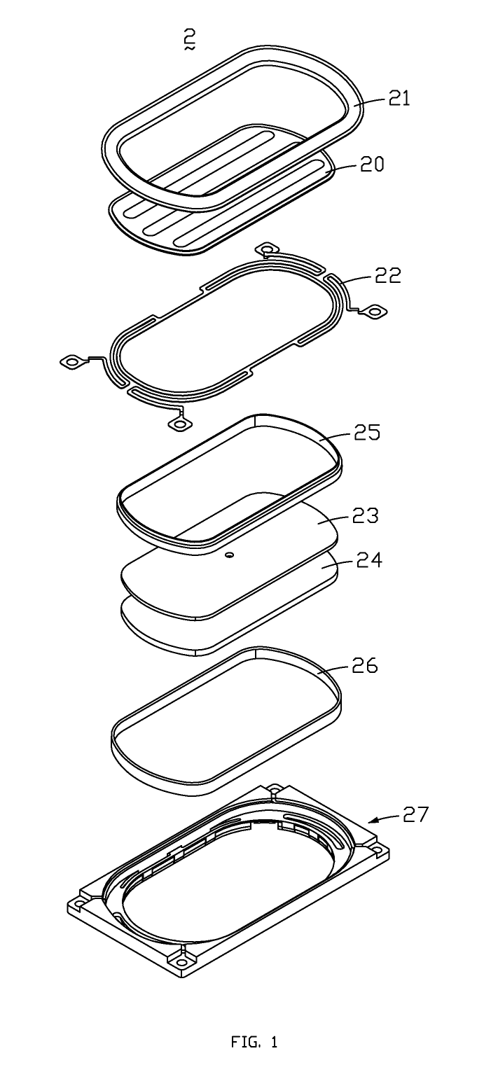

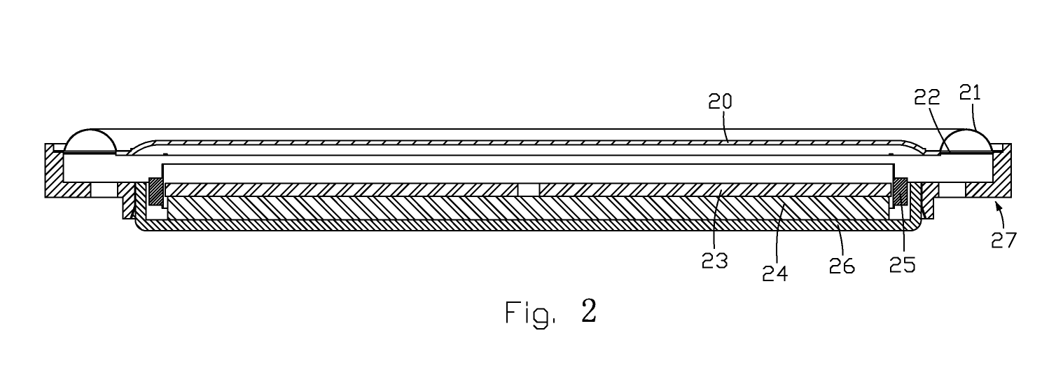

Referring to FIGS. 1-2, a speaker 2 comprises a case 27, a circuit board 22, a magnetic circuit and a vibrating device. The magnetic circuit comprises a magnetic bowl 26 coupled to the case 27, a magnet 24 positioned in the magnetic bowl 26, and a pole plate 23 covering the magnet 24. A magnetic gap is formed by the magnet 24 and the magnetic bowl 26. The vibrating device includes a diaphragm supported by the case 27 and vibrating along a vibrating direction and a voice coil 25 connected to the diaphragm. The diaphragm comprises a main body 20 and a margin 21 extending from the periphery of the main body 20 to a direction away from a centre of the main body 20. A plurality of ribs are arranged to be positioned on a surface of the main body 20. In the exemplary embodiment, the voice coil 25 is attached to the diaphragm by virtue of the circuit board 22. The circuit board 22 is used to electrically connect to leads of the voice coil and then connect to an external circuit. In fact, the circuit board 22 is optional, and without the circuit board 22, the voice coil 25 can be directly connected to a lower surface of the diaphragm and leads thereof can be directly connected to the external circuit. In addition, the circuit board 22 means a medium for connecting the voice coil to the external circuit, and it can be a printed circuit board, an elastic plate having conductive elements, or other member having conductive elements.

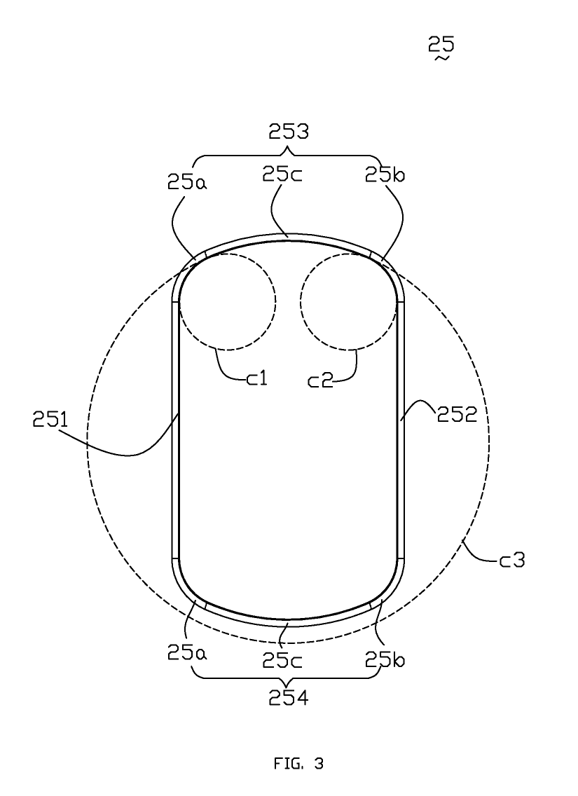

Referring to FIG. 3, the voice coil 25 comprises a first main member 251, a second main member 252 parallel to the first main member 251, a first linking member 253 connecting two ends of the first and second main members 251, 252 at a first side, and a second linking member 254 connecting another two ends of the first and second main members 251, 252 at a second side opposed to the first side. The first main member 251, the second main member 252, the first linking member 253 and the second linking member 254 define a closed loop together. The first linking member 253 defines a first arc 25a connecting to the first main body 251, a second arc 25b connecting to the second main body 252, and a third arc 25c connecting and located between the first arc 25a and the second arc 25b. A curvature radius of the first arc 25a or the second arc 25b is less than that of the third arc 25c. It is optional that the curvature radius of the first arc 25a is equal to that of the second arc 25b. Another word, the first linking member 253 has at least two different curvature radiuses. It is optional that the second linking member 254 has the same configuration to the first linking member 253. In order to achieve the configuration described above, as illustrated in FIG. 3, the first arc 25a is a part of a first circle C1 having a first diameter, the second arc 25b is a part of a second circle C2 having a second diameter equal to the first diameter, and the third arc 25c is a part of a third circle C3 having a third diameter greater than the first diameter.

As the linking member includes a portion having a greater curvature radius than the other portions, length of the voice coil is effectively reduced without affecting the sensitivity of the speaker. In addition, with a portion having a greater curvature radius than other portions, the voice coil is expanded along a radial direction, which enables the main body of the diaphragm to be enlarged. As a result, the acoustic performance of low frequency is accordingly improved.

While the present invention has been described with reference to specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. A speaker comprising:
a magnetic circuit defining a magnetic gap;
a vibrating device having a voice coil and a diaphragm, the voice coil being partially received in the magnetic gap;
the voice coil comprising:
a first main member;
a second main member being parallel to the first main member;
a first linking member connecting two ends of the first and the second main members at a first side;
a second linking member connecting two ends of the first and the second main members at a second side opposed to the first side; a closed loop formed by the first main member, the second main member, the first linking member and the second linking member; wherein the first linking member includes:
a first arc connecting to the first main body and having a first curvature radius;
a second arc connecting to the second main body and having a second curvature radius;
and a third arc located between the first arc and the second arc and having a third curvature radius greater than each of the first and second curvature radiuses.

2. The speaker as described in claim 1, wherein the first curvature radius is equal to the second curvature radius.

3. The speaker as described in claim 2, wherein the second linking member is configured to be the same to the first linking member.

4. The speaker as described in claim 2, wherein the first arc is a part of a first circle having a first diameter, the second arc is a part of a second circle having a second diameter equal to the first diameter, and the third arc is a part of a third circle having a third diameter greater than the first diameter.

5. A speaker comprising a voice coil, the voice coil comprising:
a first main member;
a second main member parallel to the first main member;
two linking members connecting ends of the first and second main members for forming a closed loop, at least one of the linking member including a first arc connecting to the first main member, a second arc connecting to the second main member, and a third arc connecting the first and second arcs, wherein each of the first and second arcs has a degree of curve higher than a degree of curve of the third arc.

6. The speaker as described in claim 5, wherein the first arc has a first curvature radius equal to a second curvature radius of the second arc.

7. The speaker as described in claim 6, wherein the two linking members include a first linking member and a second linking member configured to be the same to the first linking member.

8. A speaker comprising a voice coil, the voice coil comprising two parallel main members and two linking members connecting the two main members for forming a closed loop, one of the linking member having at least a first part from a first circle having a first diameter, and at least a second part from a second circle having a second diameter greater than the first diameter.

9. The speaker as described in claim 8, wherein the voice coil further comprises a third part from a third circle having a third diameter equal to the first diameter.
